(19) United States
(12) Patent Application Publication
(10) Pub. No.: US 2004/0090455 A1
(43) Pub. Date: May 13, 2004

(54) System for forming synchronous information of melody and image, and a system for synchronously producing melody and image

(75) Inventor: Jun Iida, Kyoto-shi (JP)

Correspondence Address: SUGHRUE MION, PLLC, 2100 PENNSYLVANIA AVENUE, N.W., SUITE 800, WASHINGTON, DC, 20037, US

(73) Assignee: ROHM CO., LTD.

(21) Appl. No.: 10/688,888

(22) Filed: Oct. 21, 2003

(30) Foreign Application Priority Data
Oct. 22, 2002 (JP) 2002-307065

(51) Int. Cl. G09G 5/00

(52) U.S. Cl. 345/728

(57) ABSTRACT

There is provided a melody and image synchronous generation system wherein melody and images matching thereto are synchronously generated at a communication terminal such as a mobile phone. With the communication terminal comprising a melody generator, an image generator, and event timing detection means for detecting event information inserted in melody information, when the event information inserted in the melody information is detected while melody is being generated, the image generator generates an image renewed based on image, information at timing of such a detection.

### FIELD OF THE INVENTION

The invention relates to a creation system of melody and image synchronous information for use in reproduction of images in synchronization with melody, and a melody and image synchronous generation system for generating images in synchronization with melody based on the melody and image synchronous information created by the creation system of the melody and image synchronous information.

### BACKGROUND OF THE INVENTION

Service for providing images accompanied by melody, for example, what is so-called on-line or on demand karaoke, has been in widespread use, and as a form thereof, it has been a popular practice to enjoy karaoke music by transmitting melody and images matching thereto from a on-line or on demand karaoke site to a communication terminal, for example, a mobile phone to be reproduced on the side of the mobile phone.

Now, i-APPLI (JAVA: trade mark) program is well known today as software for providing communication terminals with melody and images although this is not disclosed in Patent Document. However, when an attempt is made to play karaoke music with the use of this program, there occurs a time lag between melody and image renewal because a melody source is operating asynchronously with image generation, so that a problem is encountered in that errors occur over time although both the melody and image renewal are in agreement with each other at the start of karaoke music, causing both the melody and image renewal to be out of synchronization with each other.

As means or a method of solving the problem, there are disclosed in, for example, Patent Document 1 karaoke data incorporating words extraction data for synchronizing and integrating time-wise accompanying music data, described in MIDI mode, with accompanying music to thereby provide synchronization with each other, and in Patent Document 2 karaoke data comprising accompanying music data serving as an origin of karaoke performance, and character data of words serving as an origin of images of the words, appearing on the display of a karaoke performance terminal, in synchronization with accompanying music.

However, these descriptions do not disclose specific configuration showing how the accompanying music is synchronized with the words in specific terms.

Further, as other means, there is available yet another one, although not disclosed in Patent Document, whereby frame by frame advance of moving picture is executed to correct a time lag by monitoring with a fixed timer with periodicity of, for example, 10 to 20 ms, using a watch timer, and causing an event to be generated specifically, for example, for every 10 ms.

FIG. 7 is a schematic illustration showing a time lag occurring between generation timing of melody and that of an image when controlling the generation timing of both by use of the watch timer. In the figure, melody is shown along the vertical axis and a moving picture image is shown along the horizontal axis, indicating how a time lag between both occurs due to delay in renewal of the image even if both start simultaneously.

Thus, even with the use of the watch timer, there occurs some time lag between melody information and image information due to delay in frame advance of the image, and the time lag cannot be eliminated. But there is more, and if the tempo of melody is changed by a user I/F (key button) of a communication terminal while karaoke is in operation, an effect of this on the side of an application program is significant, so that there arise a problem in that processing for change in the tempo of the melody and the images (moving picture) is delayed, resulting in further increase in time lag.

Patent Document 1

JP, 2002-6869, A (Paragraph No. 0016)

Patent Document 2

JP, 2002-148169, A (Paragraph No. 0020)

### SUMMARY OF THE INVENTION

It is therefore an object of the invention to cause character advance and renewal of background images to exactly coincide with melody without a time lag therebetween when playing karaoke music with a portable communication terminal such as, for example, a mobile phone, or to cause choreograph to coincide with melody even when providing an instructional material such as choreograph of dance in 3-D image if received melody with moving picture images attached is reproduced.

To that end, the invention provides in its first aspect a creation system of melody and image synchronous information comprising event information insertion means for inserting event information in melody information at timing of image renewal, matching melody, for reproduction of images in synchronization with melody.

In accordance with a second aspect of the invention, there is provided a melody and image synchronous generation system comprising, melody generation means for generating melody based on melody information, event information detection means for detecting event information inserted in the melody information, and image generation means for generating images at timing of respective detections of the event information by the event information detection means on the basis of image information.

In accordance with a third aspect of the invention, the melody and image synchronous generation system according to the second aspect of the invention further comprises image timing control means for controlling timing of image generation at the image generation means on the basis of the event information detected by the event information detection means.

In accordance with a fourth aspect of the invention, the melody and image synchronous generation system according to the second or third aspect of the invention further comprises receiving means incorporating storage means for storing the melody information and the image information as received.

### BRIEF DESCRIPTION OF THE DRAWINGS

FIG. 1 is a block diagram broadly showing an embodiment of a melody and image synchronous generation system according to the invention;

FIG. 2 shows an example of a data row with event information inserted in melody data;

FIG. 3 is a flowchart for illustrating a procedure for operation of the melody and image synchronous generation system;

FIG. 4 is a block diagram showing another embodiment of a melody and image synchronous generation system according to the invention;

FIG. 5 is a flow chart for illustrating a procedure for processing at a portable terminal shown in FIG. 4;

FIG. 6 is a block diagram for broadly illustrating a process of causing event-generating information to be contained in melody data; and

FIG. 7 is a schematic illustration showing a time lag occurring between generation timing of melody and that of an image when controlling the generation timing of both by use of a watch timer.

### PREFERRED EMBODMENTS OF THE INVETION

Embodiments of the invention are described hereinafter with reference to the accompanying drawings.

FIG. 1 is a block diagram broadly showing an embodiment of a melody and image synchronous generation system according to the invention. The melody and image synchronous generation system according to the invention comprises melody and image information storage means 10 having melody (other sound data included) data (information) 12, image (characters included) data (information) 14, and a schedule program 16 for controlling a schedule of timing at which the melody data and the image data are changed, respectively, schedule making means 20 for making a reproduction schedule of the melody data by executing the schedule program 16, event timing detection means 30 for detecting event information in the melody data, image timing control means 40 for instructing timing of a image data renewal (a frame advance) on the basis of event timing as detected by the event timing detection means 30, a melody generator 50 for generating melody as detected by the event timing detection means 30, a speaker 70 for outputting melody as generated, an image generator 60 for generating images at timing controlled by the image timing control means 40 on the basis of the image information as stored, and a display panel 80 for displaying the image.

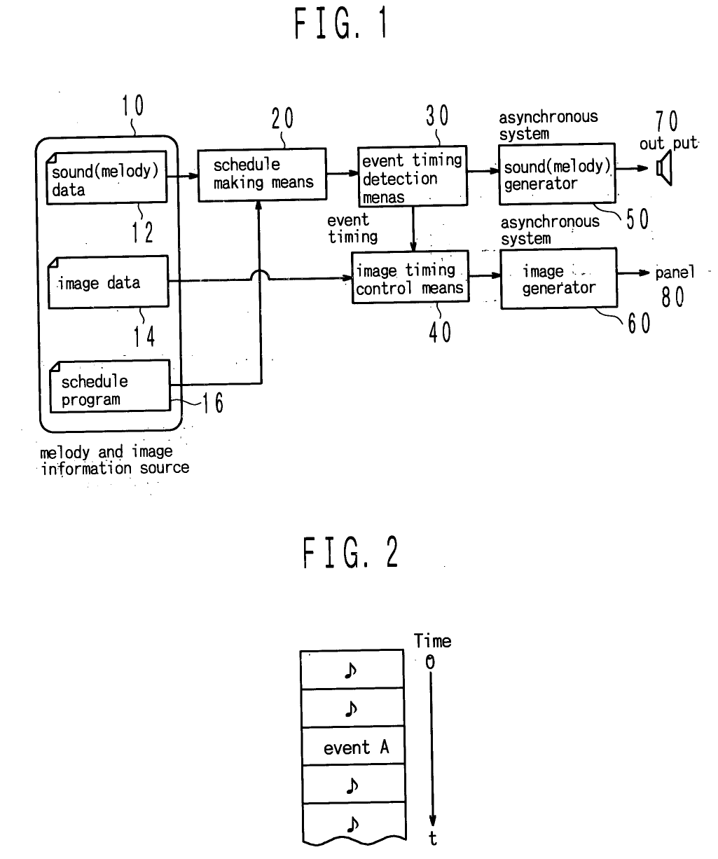

FIG. 2 shows an example of data to be processed by the melody and image synchronous generation system shown in FIG. 1, that is, a data row with event information inserted in melody information.

Because the event information is inserted at a position where an image is renewed so as to match melody data, that is, prior to a succeeding piece of the melody information, change of melody is synchronized with renewal of images, so that it is possible to eliminate a time lag that would occur at the time of image renewal as in the case of synchronization by use of a watch timer.

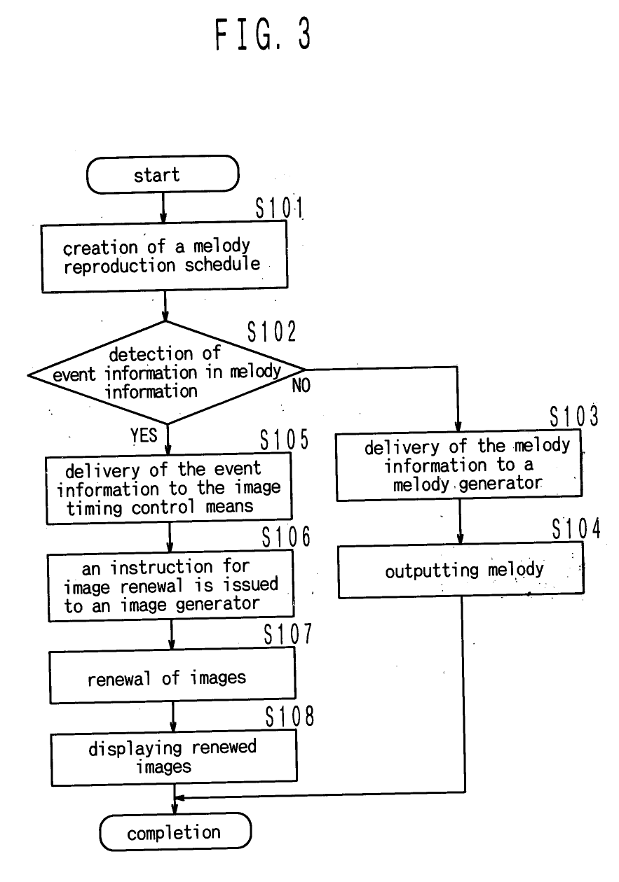

FIG. 3 is a flow chart for illustrating a procedure for operation of the melody and image synchronous generation system.

More specifically, when generating melody and images at a communication terminal, the schedule making means 20 first makes the reproduction schedule of the melody information (data) containing event information read from the information storage means 10 based on the schedule program 16 (S101), and delivers the melody information to the event timing detection means 30 according to the generation schedule. Subsequently, the event timing detection means 30 detects the event information in the melody information delivered from the schedule making means 20 (S102), and when the event information is not detected, that is, when the melody information (data) is received (S102, NO), delivers the melody information (data) to the melody generator 50 (S103), thereby outputting melody from appropriate melody generation means such as headphones, the speaker 70, and so forth (S104)

In the step S102, when the event information is detected (S102, YES), the event timing detection means 30 delivers the event information to the image timing control means 40 (S105). The image timing control means 40 takes in the image information sat timing when the event information is delivered, and delivers the same to the image generator 60 (S106). The image generator 60 renews an image on the basis of the image information delivered thereto (S107). That is, the event timing detection means 30 starts processing at time 0, and when event information “A” shown in FIG. 2 appears, delivers the event information “A” to the image timing control means 40, whereupon the image generator 60 executes the event information “A”, that is, renews an image a that timing, displaying a renewed image on display means such as the display panel 80, and so forth (S108).

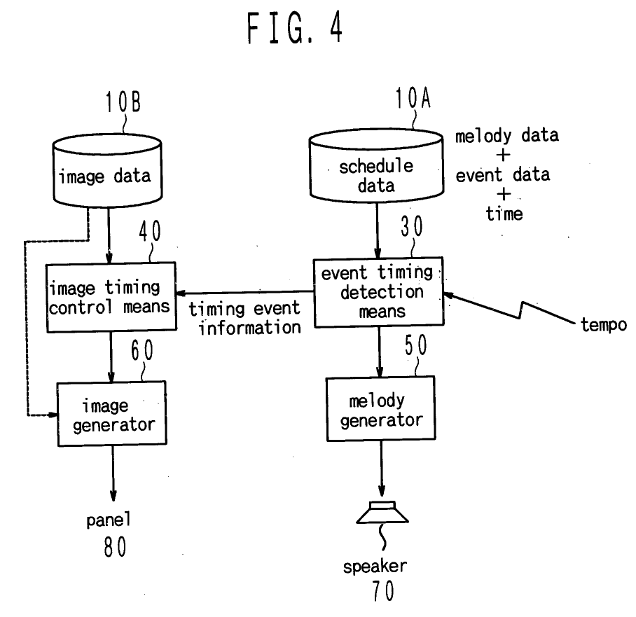

FIG. 4 is a block diagram showing another embodiment of a melody and image synchronous generation system according to the invention. In the figure, parts corresponding to those in FIG. 1 are denoted by the same reference numerals. The melody and image synchronous generation system comprises schedule data storage means 10A for storing schedule data received from, for example, a karaoke site, that is, melody information (data) with event information (data) inserted therein and playtime information thereof, and other components of the generation system, more specifically, event timing detection means 30, image timing control means 40 for controlling generation of images, a melody generator 50, an image generator 60, melody output means 70 such as a speaker, and a display panel 80 are the same as those described with reference for FIG. 1.

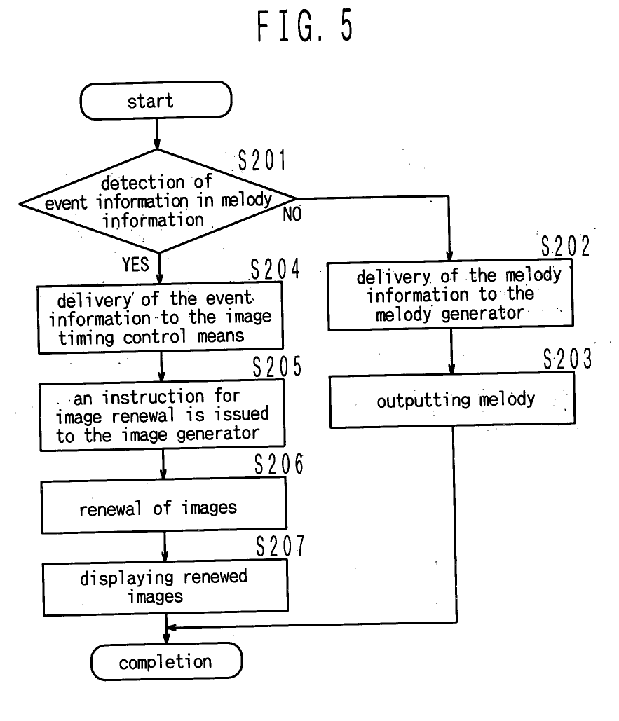

FIG. 5 is a flow chart for illustrating a procedure for processing at the melody and image synchronous generation system shown in FIG. 4.

When generating melody and images, whether or not the event information is included in the schedule data received from, for example, a karaoke site is determined (S201), and if the melody data instead of the event information is detected (S201, NO), the melody generator 50 generates melody (S202), thereby outputting the melody via the melody output means 70 such as a speaker and so forth (S203).

If the event information is detected in the step S201 (S201, YES), the event information is delivered to the image timing control means 40 (S204). The image timing control means 40 instruct timing for renewal of image data (frame advance) to the image generator 60 at event timing detected by the event timing detection means 30 (S205), thereby generating images (S206) to be displayed on the display panel 80 (S207). In this case, the image timing control means 40 may take in melody information from image data storage means 10B and may deliver the same to the image generator 60, but alternatively the image generator 60 may take in the melody information, directly from the image data storage means 10B by means of an instruction of the image timing control means 40.

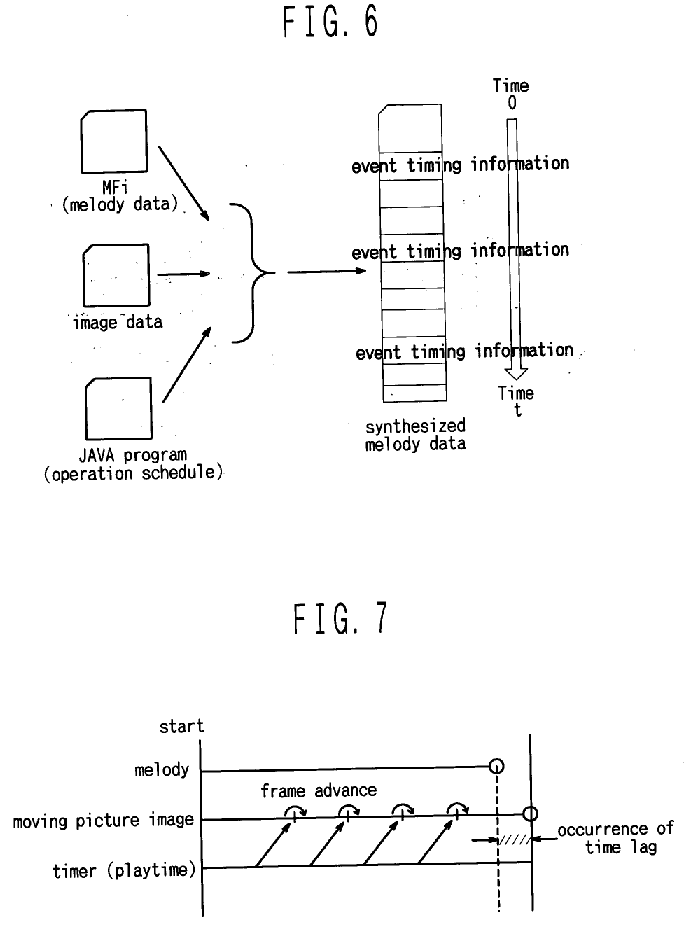

FIG. 6 is a block diagram for broadly illustrating a process of causing event-generating information to be-contained in-melody data created by a public known creation system of melody data with reference to an embodiment of a creation system of melody and image synchronous information according to the invention.

In this case, event information is inserted in melody data at timing of image renewal matching melody by processing JAVA (registered trade mark) program (action schedule control program) with software.

With the invention, the event information is detected by servicing an interrupt of the event-information in the melody data, and by generating respective renewed images at timing of respective detections, respective images can be generated (reproduced) in synchronization with melody in the melody generator 50 and the image generator 60 that are originally in asynchronous state.

With the creation system for melody and image synchronous information, even if the tempo of a musical piece is changed when synchronizing choreographed images with Karaoke music, timing of event generation is also changed following such a change in the tempo so as to match the tempo of the musical piece, so that choreographed images do not become out of synchronization with melody.

The invention has an advantageous effect in that since by servicing an interrupt of event information in melody data, the event information is detected at a time of melody generation (reproduction), and at timing of such detection, images are renewed, so that it is possible to implement synchronization in the melody generator 50 and the image generator 60 that are originally in asynchronous state. In particular, even if the tempo of melody is changed in the middle of playing karaoke, the detection timing of the event information is also changed as a result of such a change, so that there occurs no time lag between melody and image.

With the systems according to the invention, that is simple in configuration, image can be synchronized with melody, so that the so-called on-line or on demand karaoke and so on can be enjoyed with ease.

What is claimed is:

1. A creation system of melody and image synchronous information comprising event information insertion means for inserting event information in melody information at timing of image renewal in matching with said melody, for reproduction of images in synchronization with melody.

2. A melody and image synchronous generation system comprising:
melody generation means for generating melody based on melody information;
event information detection means for detecting event information inserted in the melody information; and
image generation means for generating images at timing of respective detections of the event information by the event information detection means on the basis of image information.

3. A melody and image synchronous generation system according to claim 2, further comprising image timing control means for controlling timing of image generation at the image generation means on the basis of the event information detected by the event information detection means

4. A melody and image synchronous generation system according to claim 2 or 3, further comprising receiving means incorporating storage means for storing the melody information and the image information as received.
